(19) United States
(12) Patent Application Publication
(10) Pub. No.: US 2017/0021359 A1
(43) Pub. Date: Jan. 26, 2017

(54) GRINDING MILL

(71) Applicant: TOYOTA JIDOSHA KABUSHIKI KAISHA, Toyota-shi (JP)

(72) Inventor: Masayuki NAKAMURA, Toyota-shi (JP)

(73) Assignee: TOYOTA JIDOSHA KABUSHIKI KAISHA, Toyota-shi (JP)

(21) Appl. No.: 15/216,112

(22) Filed: Jul. 21, 2016

(30) Foreign Application Priority Data
Jul. 23, 2015 (JP) 2015-146063

(51) Int. Cl. B02C 13/288; B02C 23/34; B02C 23/30; B02C 13/24

(52) U.S. Cl. CPC B02C 13/288; B02C 13/24; B02C 23/34; B02C 23/30

(57) ABSTRACT

A grinding mill includes: a disc having a plurality of pins that grind a material to be ground; a housing that rotatably houses the disc; a collection port through which a ground material obtained by grinding the material to be ground is collected; a ground material flow passage that connects the housing and the collection port to each other; and an air return flow passage that is branched from the ground material flow passage and connected to the housing.

### INCORPORATION BY REFERENCE

The disclosure of Japanese Patent Application No. 2015-146063 filed on Jul. 23, 2015 including the specification, drawings and abstract is incorporated herein by reference in its entirety.

### BACKGROUND OF THE INVENTION

1. Field of the Invention

The present invention relates to a grinding mill that produces a ground material by grinding a material to be ground fed thereinto.

2. Description of Related Art

A pin-disc milling apparatus has been disclosed as one type of impact grinders (e.g., see Japanese Patent Application Publication No. 2001-247906). The pin-disc milling apparatus described in JP 2001-247906 A has a configuration in which two discs, each with a plurality of pins arrayed on one side thereof, face each other such that the pins of the discs do not collide with each other. At least one of the two discs rotates at high speed. A material to be ground that is ground by the pin-disc milling apparatus is sent into the clearance space across which the two discs face each other, and the material to be ground collides with the pins on the rotating disc and the pins on the stationary disc and is ground by the collision impact.

A method for manufacturing powder of iron-based magnetic material alloy described in JP 2001-247906 A includes the steps of preparing an iron-based magnetic material alloy containing 50 mass % or more of iron, and grinding the iron-based magnetic material alloy with a pin milling apparatus of which the part coming into contact with the iron-based magnetic material alloy is at least partially formed from a hardmetal material. According to JP 2001-247906 A, a method for manufacturing powder of iron-based magnetic material alloy can be provided, by which, even when an iron-based magnetic material alloy is ground with the pin milling apparatus, the pins etc. do not wear in a short time and the grain size distribution of the powder undergoes little change over time.

### SUMMARY OF THE INVENTION

The above grinding mill includes the rotating disc having the plurality of pins that grind a material to be ground. Accordingly, a centrifugal force is generated by the rotation of the disc, and an airflow from the center of the disc toward the radially outer side is generated by the centrifugal force. This airflow may cause a reduction in the ground material collection efficiency by scattering the ground material to be collected upon reaching a ground material collection port through a ground material flow passage through which the ground material is collected.

The present invention provides a grinding mill that can enhance the ground material collection efficiency by reducing the flow rate of air reaching the ground material collection port.

A grinding mill according to an aspect of the present invention includes: a disc having a plurality of pins that grind a material to be ground; a housing that rotatably houses the disc; a collection port through which a ground material obtained by grinding the material to be ground is collected; a ground material flow passage that connects the housing and the collection port to each other; and an air return flow passage that is branched from the ground material flow passage and connected to the housing.

To collect a ground material by grinding a material to be ground with the grinding mill of this aspect, the disc housed in the housing is rotated and the material to be ground is fed into the housing. Although the material to be ground is not particularly limited, for example, an iron-based magnetic material alloy etc. can be used. The material to be ground having been fed into the housing is thrown by the centrifugal force of the disc from the rotation center of the disc toward the radially outer side, and in that process, the material to be ground is ground into a granular ground material by colliding with the plurality of pins of the rotating disc and discharged from the housing. In this case, an airflow from the rotation center of the disc toward the radially outer side is generated by the centrifugal force of the disc. The ground material discharged from the housing flows into the ground material flow passage along with the airflow, and is transferred through the ground material flow passage to the collection port through which the ground material is collected.

Here, the grinding mill of this aspect includes the air return flow passage that is branched from the ground material flow passage and connected to the housing. Accordingly, before reaching the collection port, most of the airflow flowing along with the ground material from the housing into the ground material flow passage branches from the ground material flow passage into the air return flow passage and returns to the housing. Thus, the flow rate of air reaching the collection port is significantly reduced compared with when the air return flow passage is not provided.

Meanwhile, being heavier than air, the ground material flowing along with the airflow from the housing into the ground material flow passage mostly reaches the collection port without flowing into the air return flow passage that is branched from the ground material flow passage. Even if part of the ground material flows into the air return flow passage along with the airflow, almost the entire part falls under the force of gravity and returns to the ground material flow passage, with only a fraction of the ground material returning to the housing.

Thus, according to the grinding mill of this aspect, it is possible to enhance the ground material collection efficiency by reducing the flow rate of air reaching the collection port through which the ground material is collected and preventing the ground material to be collected through the collection port from being scattered by the airflow.

In the above aspect, an end of the air return flow passage on the side of the housing may be connected to the housing in the vicinity of a rotation center of the disc. Thus, negative pressure is developed at the end of the air return flow passage on the side of the housing, which helps increase the flow rate of air returning from the ground material flow passage to the housing and reduce the flow rate of air reaching the collection port of the ground material flow passage.

In the above aspect, the ground material flow passage may have a filter that sifts the ground material, and the air return flow passage may be branched from the ground material flow passage on the upstream side of the filter. When passing through the filter provided in the ground material flow passage, the airflow discharged from the housing along with the ground material undergoes a pressure drop due to filter pressure loss. Therefore, if the air return flow passage is branched from the ground material flow passage on the upstream side of the filter, the airflow branching from the ground material flow passage into the air return flow passage is spared from the influence of filter pressure loss and can more easily return to the housing.

The ground material flow passage may have, as the filter, a medium-grain passing filter that does not allow passage of coarse grains within the range of a maximum average grain size but allows passage of medium grains within the range of a medium average grain size, and a fine-grain passing filter that does not allow passage of the medium grains but allows passage of fine grains within the range of a minimum average grain size. Thus, it is possible to collect the ground material sifted into coarse grains, medium grains, and fine grains.

As can be understood from the foregoing description, according to the grinding mill of this aspect, it is possible to reduce the flow rate of air reaching the ground material collection port and enhance the ground material collection efficiency by returning the airflow discharged from the housing back to the housing through the air return flow passage.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configurational view of a grinding mill according to an embodiment of the present invention;

FIG. 2 is a sectional view of a housing and a disc of the grinding mill shown in FIG. 1;

FIG. 3 is a schematic configurational view of a vibration device that vibrates a sifting section of the grinding mill shown in FIG. 1;

FIG. 4 is a schematic configurational view showing one example of a grinding mill of the related art;

FIG. 5 is a graph showing wind speeds at collection ports of the grinding mills according to an example of the present invention and a comparative example; and

FIG. 6 is a graph showing the amounts of ground material scattered in the grinding mills according to the example of the present invention and the comparative example.

### DETAILED DESCRIPTION OF EMBODIMENTS

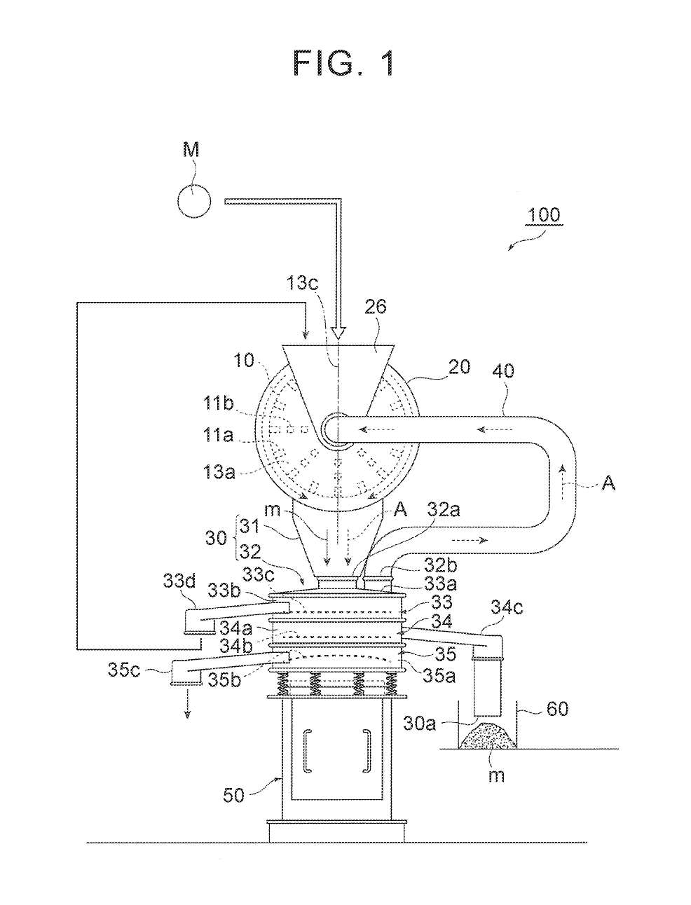

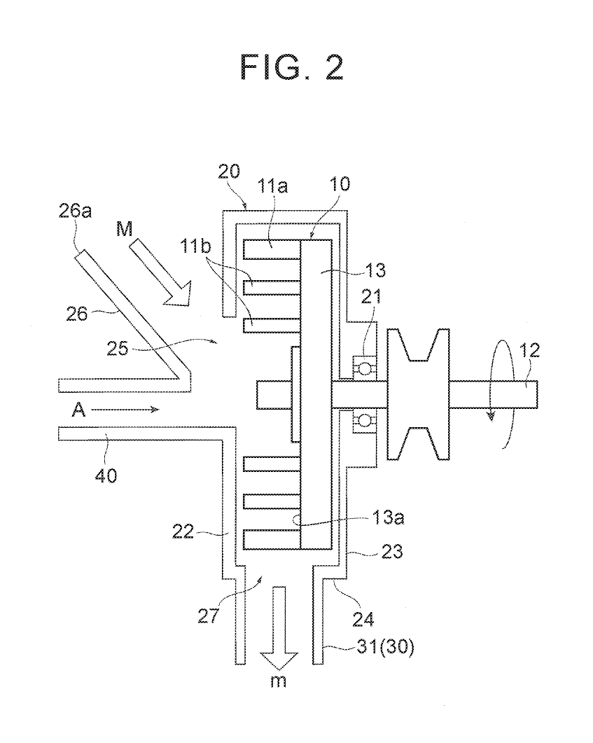

In the following, an embodiment of a grinding mill of the present invention will be described in detail with reference to the drawings. FIG. 1 is a schematic configurational view of a grinding mill 100 according to the embodiment of the present invention. FIG. 2 is a sectional view of a disc 10 and a housing 20 of the grinding mill 100 shown in FIG. 1.

The grinding mill 100 of this embodiment includes the disc 10 having a plurality of pins 11a, 11b that grind a material to be ground M, the housing 20 that rotatably houses the disc 10, a collection port 30a through which a ground material m obtained by grinding the material to be ground M is collected, and a ground material flow passage 30 that connects the housing 20 and the collection port 30a to each other and transfers the ground material m. The greatest feature of the grinding mill 100 of this embodiment is an air return flow passage 40 that is branched from the ground material flow passage 30 and connected to the housing 20.

The disc 10 has a disc-like rotating part 13 that rotates around a rotating shaft 12, and the plurality of pins 11a, 11b provided on the rotating part 13. Although the material of the disc 10 is not particularly limited, for example, a metal material, such as stainless steel, can be used. A hardmetal, such as tungsten carbide, may be used at least in a part of the pins 11a, 11b and the rotating part 13 that come into contact with the material to be ground M.

The rotating shaft 12 is fixed at the center of the rotating part 13 of the disc 10. The rotating shaft 12 is rotatably supported by a bearing 21 that is fixed to the housing 20. For example, the rotating shaft 12 is coupled to the driving shaft of a motor (not shown) through a reduction gear, and transmits the rotary power of the driving shaft to rotate the disc 10. The disc 10 can be rotated at a rotation speed of approximately 2000 rpm, for example.

On a rotating surface 13a of the rotating part 13 of the disc 10 perpendicular to the rotating shaft 12, for example, the plurality of rectangular columnar pins 11a, 11b having the same height and different sectional areas are concentrically disposed and protrude parallel to the rotating shaft 12. More specifically, six pins 11b having a smaller sectional area are disposed, three on each side of a centerline 13c of the rotating surface 13a, at equiangular intervals on a circumference around the rotating shaft 12 on the most inner peripheral side of the rotating surface 13a of the rotating part 13. On a concentric circle on the outer peripheral side of the most inner peripheral six pins 11b, eight pins 11b having a smaller sectional area, similar to the pins 11b on the most inner peripheral side, are disposed at equiangular intervals. On a concentric circle on the most outer peripheral side, 16 pins 11a having a larger sectional area are disposed at equiangular intervals.

The housing 20 has a hollow cylindrical shape with a circular top plate 22, a bottom plate 23, and a peripheral side wall 24. The housing 20 supports the rotating shaft 12 of the disc 10 through the bearing 21, and rotatably houses the disc 10. For example, a metal material, such as stainless steel, can be used as the material of the housing 20. The housing 20 is disposed such that the top plate 22 and the bottom plate 23 extend in a substantially vertical direction, and supports the rotating shaft 12 of the disc 10 so as to extend in a substantially horizontal direction.

The housing 20 has a feed port 25 through which the material to be ground M is fed, a hood 26 provided so as to cover the feed port 25, and a discharge port 27 through which the ground material m is discharged. The feed port 25 is open in the top plate 22 at a position facing the rotation center of the disc 10 and the vicinity thereof, for example, at a position facing an inner peripheral part of the most inner peripheral pins 11b of the rotating part 13. The hood 26 is increased in width from the feed port 25 toward an open end 26a, and a wall surface of the hood 26 is inclined toward the feed port 25 so as to guide the material to be ground M, fed through the open end 26a, to the feed port 25. The discharge port 27 is open on the lower side of the peripheral side wall 24.

The ground material flow passage 30 is a flow passage that connects the housing 20 and the collection port 30a to each other, and transfers the ground material m, into which the material to be ground M fed into the housing 20 is ground by colliding with the pins 11a, 11b of the disc 10, from the housing 20 to the collection port 30a. The ground material flow passage 30 has an introduction section 31 connected to the housing 20 and a sifting section 32 that sifts the ground material m.

The introduction section 31 is coupled to the discharge port 27 of the housing 20 and to an introduction port 32a of the sifting section 32, and transfers the ground material m from the housing 20 to the sifting section 32. The introduction section 31 has a tapered shape of which the opening area on the side of the sifting section 32 is smaller than the opening area on the side of the housing 20, and serves to gather the ground material m discharged from the housing 20 and introduce the ground material m into the introduction port 32a of the sifting section 32.

The sifting section 32 has a structure in which three tiers of cylindrical parts 33, 34, 35 are stacked, and sifts the ground material m into coarse grains being comparatively coarse grains, medium grains being medium-size grains, and fine grains being comparatively fine grains. More specifically, the sifting section 32 sifts the grains of the ground material m, for example, into coarse grains of which the average grain size is larger than 300 μm, medium grains of which the average grain size is 45 μm or larger but not larger than 300 μm, and fine grains of which the average grain size is smaller than 45 μm.

The upper-tier cylindrical part 33 has a disc-like top plate 33a, a cylindrical peripheral side wall 33b, a mesh-like medium-grain passing filter 33c, and a tubular coarse-grain discharge passage 33d. Of the peripheral side wall 33b, the upper side is closed by the top plate 33a and the lower side is open and communicates with the middle-tier cylindrical part 34. The top plate 33a is provided with the introduction port 32a through which the ground material m is introduced, and an air return flow port 32b. The tubular air return flow passage 40 is coupled to the air return flow port 32b. The peripheral side wall 33b has the medium-grain passing filter 33c fixed to an inner peripheral surface thereof, and the coarse-grain discharge passage 33d through which the coarse grains of the ground material m are discharged is coupled above the medium-grain passing filter 33c. The medium-grain passing filter 33c does not allow passage of the coarse grains of the ground material m but allows passage of the medium or finer grains.

The air return flow passage 40 is branched from the sifting section 32, which constitutes a part of the ground material flow passage 30, and connected to a center part of the housing 20. The air return flow passage 40 is branched from the ground material flow passage 30 on the upstream side of the medium-grain passing filter 33c of the sifting section 32. An end of the air return flow passage 40 on the side of the housing 20 is connected to the housing 20 in the vicinity of the rotation center of the disc 10. More specifically, the end of the air return flow passage 40 on the side of the housing 20 is connected to the housing 20, for example, at a position overlapping the feed port 25 of the housing 20, i.e., at a position facing the inner peripheral part of the most inner peripheral pins 11b of the rotating part 13 of the disc 10.

The middle-tier cylindrical part 34 has a cylindrical peripheral side wall 34a, a mesh-like fine-grain passing filter 34b, and a tubular medium-grain discharge passage 34c. The peripheral side wall 34a is open on the upper and lower sides, with the upper side communicating with the upper-tier cylindrical part 33 and the lower side communicating with the lower-tier cylindrical part 35. The peripheral side wall 34a has the fine-grain passing filter 34b fixed to an inner peripheral surface thereof, and the medium-grain discharge passage 34c through which the medium grains of the ground material m are discharged is coupled above the fine-grain passing filter 34b. The fine-grain passing filter 34b does not allow passage of the medium grains of the ground material m but allows passage of the fine grains. An end of the medium-grain discharge passage 34c serves as the collection port 30a through which the medium grains of the ground material m are collected as an intermediate product.

The lower-tier cylindrical part 35 has a cylindrical peripheral side wall 35a, a disc-like bottom plate 35b, and a tubular fine-grain discharge passage 35c. Of the peripheral side wall 35a, the upper side is open and communicates with the middle-tier cylindrical part 34 and the lower side is closed by the bottom plate 35b. The bottom plate 35b has a convex curved shape, with a center part of the upper surface bulging upward. The fine-grain discharge passage 35c through which the fine grains of the ground material m are discharged is coupled to the peripheral side wall 35a, above the peripheral edge of the upper surface of the bottom plate 35b. The bottom plate 35b of the lower-tier cylindrical part 35 is mounted on a vibration device 50.

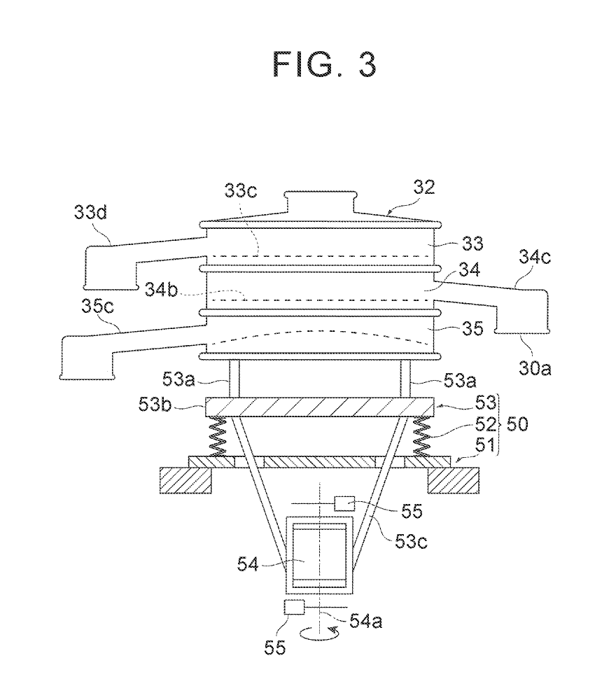

FIG. 3 is a partially sectional view showing the schematic configuration of the vibration device 50. The vibration device 50 has a base part 51, a spring 52, and a vibration part 53. The base part 51 supports the vibration part 53 through the spring 52. The vibration part 53 includes pillars 53a that support the sifting section 32, a support board 53b that supports the pillars 53a, a motor holding part 53c that is suspended from the support board 53b, a motor 54 held by the motor holding part 53c, and weights 55 rotated by the motor 54. The weights 55 are eccentric relative to a rotating shaft 54a of the motor 54, and generate vibration by rotating around the rotating shaft 54a of the motor 54.

The workings of the grinding mill 100 of this embodiment will be described below.

To collect the ground material m by grinding the material to be ground M with the grinding mill 100 of the present invention, first, the rotating shaft 12 of the disc 10 is rotated by a driving device (not shown) to rotate the disc 10 housed inside the housing 20. Moreover, the motor 54 of the vibration device 50 is driven to rotate the weights 55. Since the weights 55 of the vibration device 50 are eccentric relative to the rotating shaft 54a of the motor 54, vibration is generated as the weights 55 rotate. The vibration generated by the weights 55 is transmitted through the motor holding part 53c to the support board 53b, so that the support board 53b supported by the base part 51 through the spring 52 is vibrated, and in turn the sifting section 32 is vibrated by the support board 53b through the pillars 53a.

Next, the material to be ground M is fed into the feed port 25 of the housing 20. Although the material to be ground M is not particularly limited, for example, an iron-based magnetic material alloy etc. can be used. Here, the hood 26 can guide the material to be ground M to the feed port 25 of the housing 20, and thus feeding the material to be ground M into the feed port 25 of the housing 20 is made easy.

The material to be ground M fed into the feed port 25 of the housing 20 is thrown by the centrifugal force of the disc 10 from the rotation center of the disc 10 toward the radially outer side. In that process, the material to be ground M is ground into the granular ground material m by colliding with the plurality of pins 11a, 11b of the rotating disc 10, and is discharged through the discharge port 27 of the housing 20 and introduced into the introduction section 31 of the ground material flow passage 30. In this case, an airflow A from the rotation center of the disc 10 toward the radially outer side is generated by the centrifugal force of the disc 10, and the airflow A flows into the introduction section 31 of the ground material flow passage 30 along with the ground material m.

The ground material m and the airflow A having been introduced into the introduction section 31 of the ground material flow passage 30 is introduced into the upper-tier cylindrical part 33 through the introduction port 32a of the sifting section 32. Subjected to the vibration imparted from the vibration device 50 to the sifting section 32, the middle and finer grains of the ground material m introduced into the upper-tier cylindrical part 33 pass through the medium-grain passing filter 33c and are introduced into the middle-tier cylindrical part 34. Meanwhile, the coarse grains contained in the ground material m do not pass through the medium-grain passing filter 33c but are discharged through the coarse-grain discharge passage 33d. The discharged coarse grains may be fed again into the feed port 25 of the housing 20.

Subjected to the vibration imparted from the vibration device 50 to the sifting section 32, the fine grains among the medium and finer grains of the ground material m introduced into the middle-tier cylindrical part 34 pass through the fine-grain passing filter 34b and are introduced into the lower-tier cylindrical part 35. Meanwhile, the medium grains of the ground material m do not pass through the fine-grain passing filter 34b but are discharged through the collection port 30a at the terminal end of the medium-grain discharge passage 34c and collected into a collection container 60. In this embodiment, the collected medium grains of the ground material m are used as an intermediate product for producing a final product. Subjected to the vibration imparted from the vibration device 50 to the sifting section 32, the fine grains of the ground material m introduced into the lower-tier cylindrical part 35 are discharged through the fine-grain discharge passage 35c and collected, and recycled, for example, as a raw material for the material to be ground M.

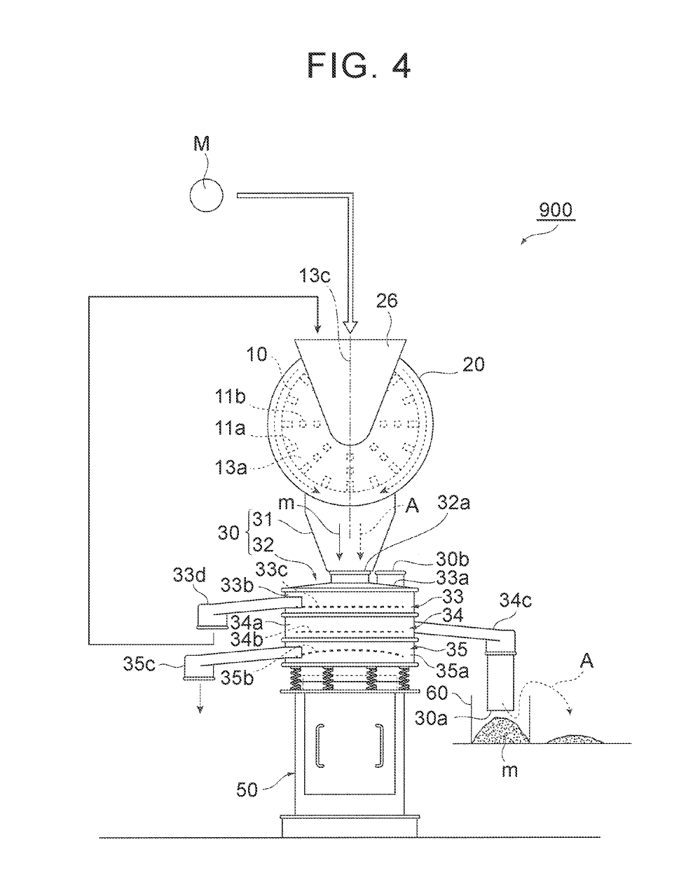

Here, for comparison with the grinding mill 100 of this embodiment, a grinding mill of the related art will be described. FIG. 4 is a schematic configurational view of a grinding mill 900 of the related art. The grinding mill 900 of the related art is different from the grinding mill 100 of the embodiment shown in FIG. 1 in that an air discharge port 30b is provided in the ground material flow passage 30 and the air return flow passage 40 is not provided. Since the grinding mill 900 shown in FIG. 4 is otherwise the same as the grinding mill 100 of the embodiment, the same parts will be denoted by the same reference signs and description thereof will be omitted.

In the grinding mill 900 of the related art, an airflow A generated by the centrifugal force of the disc 10 flows along with the ground material m from the introduction section 31 of the ground material flow passage 30 into the upper-tier cylindrical part 33 of the sifting section 32 that constitutes a part of the ground material flow passage 30. Part of the airflow A is discharged to the outside of the ground material flow passage 30 through the air discharge port 30b provided in the top plate 33a of the upper-tier cylindrical part 33. The air discharge port 30b is provided with a filter that prevents the ground material m from leaking to the outside. Thus, the air discharged through the air discharge port 30b to the outside of the ground material flow passage 30 faces high resistance, and high pressure is required to discharge the air to the outside.

For this reason, most of the airflow A flowing into the upper-tier cylindrical part 33 of the sifting section 32 is not discharged through the air discharge port 30b but reaches the collection port 30a, through which the medium grains of the ground material m are collected, through the upper- and middle-tier cylindrical parts 33, 34 as well as the medium-grain discharge passage 34c. As a result, the efficiency of collecting the ground material m may be reduced as the airflow A at high wind speed bursts out from the collection port 30a and scatters the ground material m collected in the collection container 60.

By contrast, the grinding mill 100 of the embodiment shown in FIG. 1 includes the air return flow passage 40 that is branched from the ground material flow passage 30 on the upstream side of the collection port 30a and connected to the housing 20. Therefore, before reaching the collection port 30a, most of the airflow A flowing along with the ground material m from the housing 20 into the ground material flow passage 30 branches from the ground material flow passage 30 into the air return flow passage 40 and returns to the housing 20. As a result, the flow rate of the air reaching the collection port 30a is significantly reduced compared with when the air return flow passage 40 is not provided, and the wind speed of the airflow A blowing out of the collection port 30a is reduced. Thus, it is possible to prevent the scattering of the ground material m collected in the collection container 60.

Being heavier than air, the ground material m flowing along with the airflow A from the housing 20 into the ground material flow passage 30 mostly does not flow into the air return flow passage 40 branched from the ground material flow passage 30, but is collected after being sifted by the sifting section 32 of the ground material flow passage 30. Even if part of the ground material m flows into the air return flow passage 40 along with the airflow A, almost the entire part falls under the force of gravity and returns to the sifting section 32 of the ground material flow passage 30, with only a fraction of the ground material m returns to the housing 20. Thus, according to the grinding mill 100 of the embodiment, it is possible to enhance the efficiency of collecting the ground material m by reducing the flow rate of air reaching the collection port 30a of the ground material flow passage 30 through which the ground material m is collected and preventing the ground material m collected through the collection port 30a from being scattered by the airflow A.

Moreover, in the grinding mill 100 of the embodiment, the end of the air return flow passage 40 on the side of the housing 20 is connected to the housing 20 in the vicinity of the rotation center of the disc 10. More specifically, the end is connected to the housing 20 at a position facing the inner peripheral part of the most inner peripheral pins 11b of the rotating part 13 of the disc 10. Thus, negative pressure is developed at the end of the air return flow passage 40 on the side of the housing 20, which helps increase the flow rate of air returning from the ground material flow passage 30 to the housing 20 and reduce the flow rate of air reaching the collection port 30a of the ground material flow passage 30.

In the grinding mill 100 of the present invention, the sifting section 32, which constitutes a part of the ground material flow passage 30, has the filters that sift the ground material m. Moreover, the air return flow passage 40 is branched from the ground material flow passage 30 on the upstream side of the medium-grain passing filter 33c of the upper-tier cylindrical part 33 of the sifting section 32. Thus, the pressure drop of the returning air due to filter pressure loss is prevented, so that the airflow A branching from the ground material flow passage 30 into the air return flow passage 40 can more easily return to the housing 20.

The sifting section 32 of the ground material flow passage 30 has, as the filters, the medium-grain passing filter 33c that does not allow passage of the coarse grains of the ground material m within the range of a maximum average grain size but allows passage of the medium grains within the range of a medium average grain size, and the fine-grain passing filter 34b that does not allow passage of the medium grains but allows passage of the fine grains within the range of a minimum average grain size. Thus, it is possible to sift the ground material m into coarse grains, medium grains, and fine grains, and collect only the medium grains of the ground material m through the collection port 30a.

As has been described above, according to the grinding mill 100 of the embodiment, it is possible to reduce the flow rate of air reaching the collection port 30a of the ground material m and enhance the efficiency of collecting the ground material m by returning the airflow A discharged from the housing 20 back to the housing 20 through the air return flow passage 40.

While the embodiment of the present invention has been described in detail using the drawings, the specific configuration is not limited to that of the embodiment, and any design changes etc. within the scope of the present invention are included in the present invention.

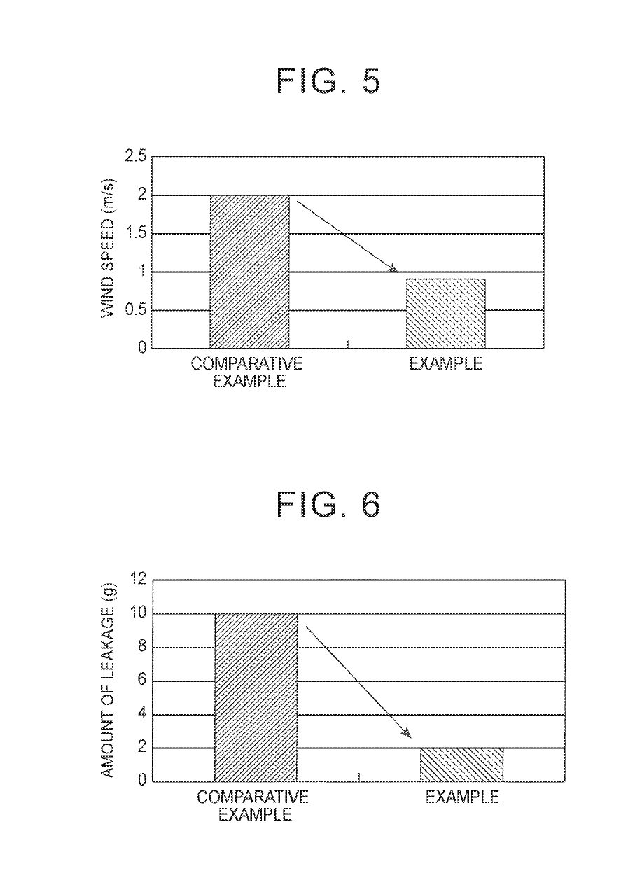

A material to be ground was ground with the grinding mill according to an example of the present invention having the configuration shown in FIG. 1, and the wind speed of air blowing out of the collection port and the weight of the ground material scattering from the collection container and leaking to the outside, i.e., the amount of leakage of the ground material, were measured. The results are shown in FIG. 5 and FIG. 6.

A material to be ground was ground with a grinding mill of the related art having the configuration shown in FIG. 4, and the wind speed of air blowing out of the collection port and the weight of the ground material scattering from the collection container and leaking to the outside, i.e., the amount of leakage of the ground material, were measured. The results are shown in FIG. 5 and FIG. 6.

As shown in FIG. 5 and FIG. 6, compared with the wind speed of the airflow blowing out of the collection port of about 2 m/s in the grinding mill of the comparative example that has no air return flow passage, the wind speed in the grinding mill of the example having the air return flow passage was lower at 1 m/s or less, which is less than half that of the comparative example. Moreover, compared with the amount of leakage from the collection container of about 10 g in the grinding mill of the comparative example, the amount of leakage in the grinding mill of the example was smaller at about 2 g, which is about a fifth of that of the comparative example.

What is claimed is:

1. A grinding mill comprising:
a disc having a plurality of pins that grind a material to be ground;
a housing that rotatably houses the disc;
a collection port through which a ground material obtained by grinding the material to be ground is collected;
a ground material flow passage that connects the housing and the collection port to each other; and
an air return flow passage that is branched from the ground material flow passage and connected to the housing.

2. The grinding mill according to claim 1, wherein:
the ground material flow passage has a filter that sifts the ground material; and
the air return flow passage is branched from the ground material flow passage on the upstream side of the filter.

3. The grinding mill according to claim 2, wherein an end of the air return flow passage on the side of the housing is connected to the housing in the vicinity of a rotation center of the disc.

4. The grinding mill according to claim 1, wherein an end of the air return flow passage on the side of the housing is connected to the housing in the vicinity of a rotation center of the disc.
